(19) United States
(12) Patent Application Publication
(10) Pub. No.: US 2002/0138492 A1
(43) Pub. Date: Sep. 26, 2002

(54) Data mining application with improved data mining algorithm selection

(76) Inventor: David Kil, Gilroy, CA (US)

Correspondence Address: WELSH & KATZ, LTD, 120 S RIVERSIDE PLAZA, 22ND FLOOR, CHICAGO, IL, 60606, US

(21) Appl. No.: 09/992,435

(22) Filed: Nov. 16, 2001

Related U.S. Application Data
(60) Provisional application No. 60/274,008, filed on Mar. 7, 2001.

(51) Int. Cl. G06F 7/00

(52) U.S. Cl. 707/100

(57) ABSTRACT

A training database (including data mining algorithm descriptions and metafeatures characterizing probability density functions of features) in the memory and computer readable program code (i) to extract features that classify data, (ii) to calculate metafeatures describing the case probability density function, and (iii) to select a data mining algorithm by using the training database to map the calculated metafeatures describing the case probability density function to the selected data mining algorithm. The frequency of the occurrence of features with respect to datum in the data defining a case probability density function.

### CROSS-REFERENCE TO RELATED APPLICATIONS

This application claims the benefit of U.S. Provisional Application Ser. No. 60/274,008, filed Mar. 7, 2001, which is herewith incorporated herein by reference. This application is related to copending application Ser. No. 09/945,530, entitled “Automatic Mapping from Data to Preprocessing Algorithms” filed Aug. 30, 2001, which is herewith incorporated herein by this reference.

### COPYRIGHT

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### BACKGROUND

Data mining is the process of extracting desired data from existing databases. Typically, there will exist a large database of recorded information. There can also exist additional data that may be recorded continually on an ongoing basis. It can be desirable to predict changes in value of one variant based on observed values of the other variants. Data mining applications generally assist in performing such analysis. This invention generally relates to a data processing apparatus and corresponding methods for the analysis of data stored in a database or as computer files.

A database is in general a collection of data organized according to a conceptual structure describing the characteristics of these data and the relationships among their corresponding entities, supporting application areas. It is a data structure for accepting, storing and providing on demand data for multiple independent users. An end user or user in general includes a person, device, program, or computer system that utilizes a computer network for the purpose of data processing and information exchange. An object of data mining is to derive, discover, and extract from the database previously unknown information about relationships between and among these data and the relationships among their corresponding entities.

The field of knowledge discovery and data mining has grown rapidly in recent years. Massive data sets have driven research, applications, and tool development in business, science, government, and academia. The continued growth in data collection in all of these areas ensures that the fundamental problem which knowledge discovery in data addresses, namely how does one understand and use one's data, will continue to be of critical importance across a large swath of organizations.

People appreciate insight into the information contained in a mass of raw data. In any given data set, a large majority of the data may be irrelevant and/or redundant. There exists a need therefore for an application that will assist people in focusing automatically on the relatively smaller proportion of data that is meaningful and useful. Information is, in general, knowledge in any form concerning objects, such as facts, events, things, processes, or ideas, including concepts, that within a certain context has a particular meaning. Data is a reinterpretable representation of information in a formalized manner suitable for communication, interpretation, or processing.

Examples of existing data mining applications include packages available in statistical analysis tools such as SAS and SPSS. These packages include many data mining algorithms (“DM-Algorithms”) which may be applied to problems of various types. For example, some types of problems are conducive to solution using multivariate Gaussian classifiers. Other types of problems are more responsive to neural network approaches. Others may respond to hybrid approach, or to a different analysis altogether.

A number of organizations currently sponsor and/or promote research, investigation, and study regarding data mining. For example, the Computer Society of IEEE promotes investigation in areas including data mining. Similarly, The Special Interest Group for Knowledge Discovery in and Data of the Association for Computing Machinery encourages basic research in data mining; the adoption of “standards” in the market in terms of terminology, evaluation, and methodology; and interdisciplinary education among data mining researchers, practitioners, and users. Research in data mining generally, however, typically does not address the problem of automated algorithm selection. Such research, therefore, while useful as background information, tends not to be directly relevant to the particular field of this invention.

Selecting the appropriate DM-algorithms for use on a particular problem is typically a tedious and time-consuming task. Users typically rely on prior knowledge of the problem set. Because many particular algorithms are available, it is difficult to know which algorithms may be most appropriate for a particular problem. Casual users of such applications often are not intimately familiar with the vast array of different algorithms available and their particular idiosyncrasies.

Even for sophisticated users with appropriate expertise, selecting the correct algorithm for a particular application may be a difficult and time-consuming process. Typically, there are a number of different algorithms which may be appropriate, and each of these different algorithms will typically have a number of different parameters which may need to be adjusted to achieve optimal performance.

In general, few guidelines are available about how to extract good performance on a particular problem set. There has been little rigorous analysis directed towards the question of what metafeatures in particular algorithms make them useful in the resolution of particular problems.

Selecting appropriate DM-algorithms thus tends to be a relatively labor-intensive process. Obtaining the services of personnel with appropriate experience and expertise may itself be a difficult task. Even if such personnel are available, making use of such resources is typically very costly. Such limitations may tend to place data mining technology beyond the reach of many users while forcing even expert users to spend an inordinate amount of time looking iteratively for an acceptable solution space.

One approach used in some existing packages is to limit the algorithm space. A goal of such packages is to avoid overwhelming the user with options. Therefore, they do not offer a comprehensive or exhaustive set of algorithms. The user ends up with access only to smaller subset of the algorithm universe. While this approach makes the packages easier for users to apply, it also tends to limit the performance of such packages. Limiting the set of algorithms often precludes optimal performance.

Some current research touts advantages of particular classifier schemes. Such investigation may add a new and useful algorithm to the repertoire of existing algorithms available for solving classes of problems. It does little, however, to explain rigorously and systematically when such an algorithm should be applied. What it ignores is the inherent relationship between good features and classifiers regardless of the problem domain.

Other research continues to develop and improve particular classifiers for certain types of problems. Such research may be useful to improve algorithm performance. It does not, however, address the issue of which algorithm is appropriate for a given class of problem.

Other literature in the field notes that no single data mining technique is adequate for all classes of problems. Such research tends to recognize that different algorithms may perform better on particular types of problems. Nothing in this research, however, provides a rigorous and systematic technique for identifying which DM-algorithms should be used on particular problem.

One recent approach suggests using Case Based Reasoning to select the correct classification algorithm. This approach relies on database containing all previously processed data sets. First, the closest match to the new data set is found using K-nearest neighbor algorithm. The similarity calculation is based on attributes that can be grouped into general, statistical, and information theoretically categories. This step is sometimes referred to as limiting. Next, the case selected matches are ranked in terms of accuracy and speed. The algorithm that performed best in light of these two criteria is selected using this adjusted ratio of ratios. Others have suggested the need to build profiles for learning algorithms. Such profiles characterize learning algorithms based on factors such as representational power and functionality, efficiency, resilience, and practicality. Such profiles may also include other properties such as scalability, biases/variance trade-off, and resistance to data anomalies.

Existing technology, therefore, does not offer any comprehensive analysis tool that automatically recommends appropriate DM-algorithms given the problem at hand. Data mining instead suggests a sense of mysticism or voodoo. Existing research fails to show underlying good feature probability distributions that explain why a particular classified works well on particular problem. Addressing this need is made more difficult by the fact that the problem of selecting appropriate classifiers as the DM-algorithms typically has a high feature dimension.

Several limitations are inherent in these approaches. First, such approaches provide no explicit mechanism to find the point of diminishing returns. Actual metafeature characteristics of the good-feature probability density function may change drastically when less useful features are included in the calculation of that attributes. It is desirable, therefore, to provide some means for reducing the feature dimension of the algorithms selection problem. Second, such approaches tended to limit the transform from problem set databases to algorithms space to one mapping algorithm. For example, the Case Based Reasoning approach restricts the use of mapping algorithm to K-nearest neighbor. There is a need, therefore, for technology providing for direct mapping from a database of problems sets into algorithms space. Third, such approaches do not consider the importance of feature robustness. Feature robustness is important because the degree of data mismatch between training and test data sets can be significant. Under these existing approaches, the actual classification performance is a function of both model- and data-mismatch errors. There is a need, therefore, to take feature robustness into account when recommending appropriate algorithms. Fourth, these approaches may rely on an additional layer of bureaucracy and abstraction. This additional layer of bureaucracy and abstraction may interfere with a learning algorithm discovering the relationship between features and algorithms. There is a need, therefore, for a solution that provides direct mapping without this additional layer of bureaucracy.

There continues to exist a need, therefore, for a better solution to the problem of selecting the appropriate data mining architecture for a given data mining exercise problem. Identifying appropriate data mining architecture should preferably provide not just rules, but the actual algorithm that transforms the input vector space spanned by good features into an output decision space. Another need is an approach to yield a robust solution regardless of the nature of the problem, in order to avoid the need to develop a new approach in a painstaking manner for each new application.

### SUMMARY

The invention, together with the advantages thereof, may be understood by reference to the following description in conjunction with the accompanying figures, which illustrate some embodiments of the invention.

One embodiment is a data mining algorithm selection method for selecting a data mining algorithm for data mining analysis of a problem set. The data mining algorithm selection method includes the act of providing data to be analyzed by data mining, the act of providing a training database, the act of extracting features that classify the data, the frequency of the occurrence of features with respect to datum in the data defining a case probability density function, the act of calculating metafeatures describing the case probability density function, and the act of selecting a data mining algorithm by using the training database to map the calculated metafeatures describing the case probability density function to the selected data mining algorithm. The training database in this embodiment includes data mining algorithm instances. Each data mining algorithm instance includes a data mining algorithm description and a set of training metafeatures characterizing probability density functions of features. This data mining algorithm selection method can also include the act of updating the training database to include the selected data mining algorithm and the calculated metafeatures as a new data mining algorithm instance. Extracting features in this data mining algorithm selection method may also include the act of identifying a point of diminishing returns in the number of features and the act of estimating the robustness of features. The act of estimating feature robustness in this embodiment may also include an act of partitioning problem set data into subsets. The act of partitioning problem set data in this embodiment may also include partitioning the data set temporally, partitioning the data set sequentially, and/or partitioning the data set randomly. Estimating feature robustness can include calculating the entropy of each subset as a statistical measure of similarity. This data mining algorithm selection method can also include identifying parameters using the identified parameters in selecting a data mining algorithm. The parameter can include user preferences, real-time deployment issues, available memory, the size of training data, and/or available throughput. Selecting a data mining algorithm can use a simple classifier. Selecting a data mining algorithm can, optionally, use a Bayesian network. Metafeatures can include the number of distinct modes of the probability density function, the degree of normality of the probability density function, and/or the degree of non-linearity of the probability density function. This data mining algorithm selection method can also include selecting more than one data mining algorithm and fusing the selected data mining algorithms into a composite data mining algorithm.

A second embodiment is a data mining product embedded in a computer readable medium containing a training database and computer readable program code. The training database includes a list of data mining algorithm instances. Each data mining algorithm instance includes a data mining algorithm description and a set of metafeatures characterizing probability density functions of features. The computer readable program code in the computer program product can extract features that classify data (with the frequency of the occurrence of features with respect to datum in the data defining a case probability density function), calculate metafeatures describing the case probability density function, and select a data mining algorithm by using the training database to map the calculated metafeatures describing the case probability density function to the selected data mining algorithm. The computer readable program code in this embodiment may also update the training database to include the selected data mining algorithm and the calculated metafeatures as a new data mining algorithm instance. The computer readable program code to extract features in this embodiment may also identify a point of diminishing returns in the number of features and estimate feature robustness. The computer readable program code to estimate feature robustness may also partition the data into subsets, temporally, sequentially, randomly, or otherwise. The computer readable program code to estimate feature robustness in this embodiment may then calculate the entropy of each subset as a statistical measure of similarity. The computer readable program code in this embodiment may also identify parameters (such as user preferences, real-time deployment issues, available memory, the size of training data, and available throughput) and use the identified parameters in the computer readable program code for selecting a data mining algorithm. The computer readable program code to select a data mining algorithm in this embodiment may use a simple classifier system, a Bayesian network, or any other suitable system. This embodiment may also calculate metafeatures such as the number of distinct modes of the probability density function, the degree of normality of the probability density function, and the degree of nonlinearity of the probability density function. This embodiment may also select more than one data mining algorithm and fuse the selected data mining algorithms into a composite data mining algorithm.

A third embodiment includes a general purpose computer having a memory and a central processing unit, a training database (including data mining algorithm descriptions and metafeatures characterizing probability density functions of features) in the memory, computer readable program code (i) to extract features that classify data, (ii) to calculate metafeatures describing the case probability density function, and (iii) to select a data mining algorithm by using the training database to map the calculated metafeatures describing the case probability density function to the selected data mining algorithm. The frequency of the occurrence of features with respect to datum in the data defining a case probability density function;

A fourth embodiment includes a distributed network of computers, a training database (including data mining algorithm descriptions and metafeatures characterizing probability density functions of features) on the network and computer readable program code (i) to extract features that classify data, (ii) to calculate metafeatures describing the case probability density function, and (iii) to select a data mining algorithm by using the training database to map the calculated metafeatures describing the case probability density function to the selected data mining algorithm. The frequency of the occurrence of features with respect to datum in the data defines a case probability density function.

### REFERENCE TO THE DRAWINGS

Several aspects of the present invention are further described in connection with the accompanying drawings in which:

FIG. 1 is a first program flowchart that generally depicts the sequence of operations in one embodiment of a program for improved data mining algorithm (“DM-algorithm”) selection based on good feature distribution.

FIG. 2 is a second program flowchart that generally depicts the sequence of operations in one embodiment of a program for improved data mining algorithm (“DM-algorithm”) selection based on good feature distribution.

FIG. 3 is a data flowchart that generally depicts the path of data and the processing steps for an example of a process for improved data mining algorithm selection based on good feature distribution.

FIG. 4 is a data flowchart that generally depicts the path of data and the processing steps for an example of a process for data mismatch detection.

FIG. 5 is a system flowchart that generally depicts the flow of operations and data flow of one embodiment of a system for improved data mining algorithm selection based on good feature distribution.

FIG. 6 is a block diagram that generally depicts a configuration of one embodiment of hardware suitable for improved data mining algorithm selection based on good feature distribution.

FIG. 7 depicts screens and windows that may be presented to the user in one embodiment for improved data mining algorithm selection based on good feature distribution.

FIG. 8 depicts a batch wizard window that may be presented to the user in one embodiment for improved data mining algorithm selection based on good feature distribution.

FIG. 9 depicts a feature generator window that may be presented to the user in one embodiment for improved data mining algorithm selection based on good feature distribution.

FIG. 10 depicts a DM wizard window that may be presented to the user in one embodiment for improved data mining algorithm selection based on good feature distribution.

FIG. 11 depicts a second DM Wizard window that may be presented to the user in one embodiment for improved data mining algorithm selection based on good feature distribution.

FIG. 12 depicts a DM wizard window and performance summary window that may be presented to the user in one embodiment for improved data mining algorithm selection based on good feature distribution.

FIG. 13 depicts a batch dialog window and why these selections window that may be presented to the user in one embodiment for improved data mining algorithm selection based on good feature distribution.

### DETAILED DESCRIPTION

While the present invention is susceptible of embodiment in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

An embodiment of the current invention provides a data mining application with improved algorithm selection. Application software or an application program is, in general, software or a program that is specific to the solution of an application problem. An application problem is generally a problem submitted by an end user and requiring information processing for its solution. For this data mining software package or program, the end user will typically seek to obtain useful information regarding relationships between the dependant variables or function and the source data.

Algorithm selection occurs automatically through use of a classifier database that associates good features with algorithms contained in or added to the classifier database subject to constraints placed by the user. This improved algorithm selection is based not merely and only on heuristic rules for identifying suitable algorithms. Instead, algorithm selection is based on metafeatures characterizing a good feature distribution. Metafeatures are the features of features, meaning that a set of additional features is extracted to describe the underlying features that parameterize the original data mining problem. These additional features are called metafeatures. In a particular embodiment, algorithm selection is improved through metafeature extraction, data mismatch detection, distribution characterization, parameterization of classification, and continuous updating. These processes automatically suggest appropriate data mining algorithms and assist the user in selecting appropriate algorithms and refining performance.

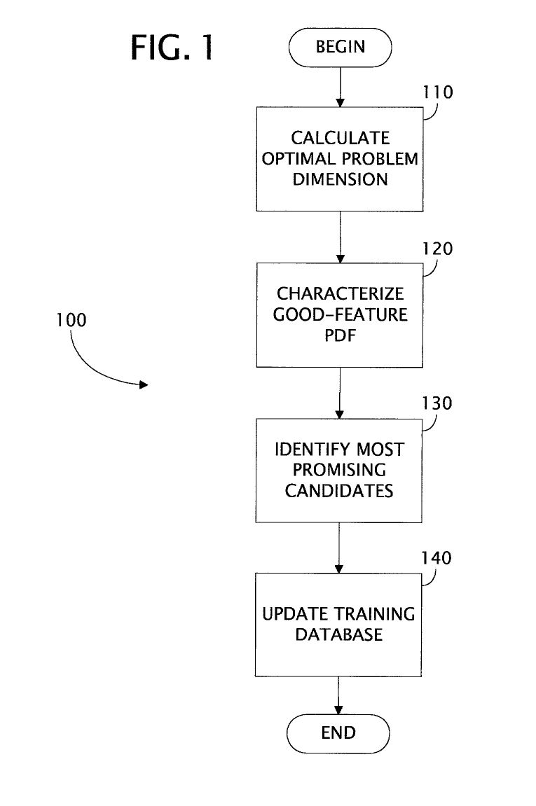

Referring now to FIG. 1, there is shown a program flowchart illustrating the sequence operations in a first embodiment of a program (100) for improved data mining algorithm (“DM-algorithm”) selection based on the good feature distribution, or probability density function. A program or computer program is generally a syntactic unit that conforms to the rules of a particular programming language and that is composed of declarations and statements or instructions needed to solve a certain function, task, or problem; a programming language is generally an artificial language for expressing programs. This embodiment includes a calculate-optimal-problem-dimension process (110), a characterize-good-feature probability-density-function-process (120), an identify-most-promising-candidates process (130), and an update-training-database process (140).

When the first embodiment of a program (100) depicted in FIG. 1 begins, control passes first to the calculate-optimal-problem-dimension process (110). Actual metafeature characteristics may change significantly when less helpful features are included in the final feaure subset from which metafeatures are derived. In this embodiment the calculate-optimal-problem-dimension process (110) may also in one mode assess feature robustness. The calculate-optimal-problem-dimension process (110) in this embodiment identifies the point at which adding more features does not enhance DM-algorithm performance. It may reduce the problem dimension using techniques such as subspace filtering, single dimensional feature ranking, multidimensional (MD) combinatorial optimization, and MD visualization. This step is analogous to understanding how many input features are required to form a sufficient statistic for a given problem. The features included in the feature subset at the point of diminishing returns are then characterized for a compact description of their joint and marginal distributions.

After the calculate-optimal-problem-dimension process (110), control in this embodiment passes next to the characterize-good-feature-probability-density-function process (120). The characterize-good-feature-probability-density-function process (120) of this embodiment computes metafeatures that characterize the good feature distribution. The underlying good-feature probability density function can thus be described as a compact vector of metafeatures. User preferences and data characteristics such as real-time deployment issues, available memory, the size of training data, and available throughput may be appended to this compact vector of metafeatures. This augmented vector in one embodiment can then be used as the basis for selecting a DM-algorithm. The metafeatures describe what the good features in the feature subset look like in the multidimensional feature space using a variety of statistical, vector quantization, transform, and image processing algorithms.

Referring still to the embodiment in FIG. 1, after the characterize-good-feature-probability-density-function process (120) completes control passes next to the identify-most-promising-candidates process (130). The identify-most-promising-candidates process (130) of this embodiment discovers the most promising DM-algorithm candidates for the specific data mining problem presented for solution. The identify-most-promising-candidates process (130) bases its identification in part on the characterization of the good-feature probability density function calculated by the characterize-good-feature-probability-density-function process (120). The identify-most-promising-candidates-process (130) also bases its identification in part on user preference supplied by the user concerning real-time implementation of a candidate DM-algorithm. These two bases serve as constraining factors used in one embodiment by a hybrid Bayesian network to map the input metafeatures and user preferences onto an output DM-algorithm space. This mapping produces a ranking of candidate DM-algorithms, from which the most promising DM-algorithms are identified.

After the identify-most-promising-candidates process (130) completes, control in this embodiment passes next to the update-training-database process (140). The training database is initially equipped with the entire available collection of data mining experiences with real data at the origination point. Each new case or instance (comprising the augmented vector listing good probability density function metafeatures, user preferences and data characteristics, and the identified most promising DM-algorithms) is added to the training database as a new experience. After the update-training-database process (140) completes, the DM-algorithm selection program ends execution. Control may then be passed to another process (not pictured), such as, for example, an application of the DM-algorithm or DM-algorithms selected to the case or instance data, or the application may terminate.

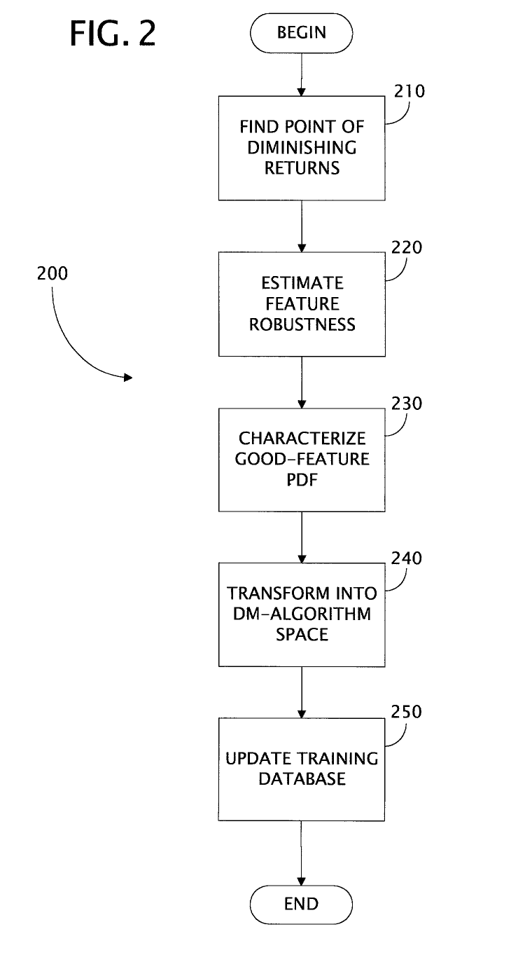

Referring now to FIG. 2, there is shown a program flowchart illustrating the sequence operations in a second embodiment of a program (200) achieving improved DM-algorithm selection based on characteristics (metafeatures) of the good feature distribution. This second embodiment includes a find-point-of-diminishing-returns process (210), an estimate-feature-robustness process (220), a characterize-good-feature-probability-density-function process (230), a transform-into-DM-algorithm-space process (240), and an update-training-database process (250). This second embodiment of a program (200) can realize many of the same benefits and advantages of the first embodiment of a program (100). As shown by this similar result, the particular division of program code into coding modules is not material to this invention provided that the operations are performed. In other additional embodiments (not illustrated) the operations may be further divided into additional processes, or processes here illustrated may be combined to produce the same result. Such minor variations are considered the same as or equivalent to these illustrated exemplary embodiments.

Within the second embodiment of a program (200) control passes first to the find-point-of-diminishing-returns process (210). Generally there exists a number of classifiers such that the inclusion of more features does not improve performance in algorithm selection. The find-point-of-diminishing-returns process (210) identifies a relatively small number of good features, in comparison to the universe of possible features. The find-point-of-diminishing-returns process (210) calculates optimal problem dimension. The dimension of the problem is the number of distinct features encompassed when a performance inflection point occurs. The find-point-of-diminishing-returns process (210) finds a point of diminishing returns, i e., the point at which the inclusion of more features does not enhance the selection of the most appropriate DM-algorithm. This procedure eliminates redundant and irrelevant features from further consideration.

When the find-point-of-diminishing-returns process (210) is completed, control passes next to the estimate-feature-robustness process (220). The estimate-feature-robustness process (220) assesses the ability of the classifier to handle data mismatch. The estimate-feature-robustness process (220) in this embodiment partitions the entire data set into separate training and test subsets and characterizes underlying good feature distributions. It then computes statistical measures of similarity. The entropy of the subset is one example of such a statistical measure. Other information theoretic measures can be computed in other modes of practicing this embodiment. In each of these modes, the estimate-feature-robustness process (220) of this embodiment quantifies the degree of data mismatch as a function of good features. In general, this estimate-feature-robustness process (220) quantifies data mismatch.

The program estimates feature robustness because some classifiers are better at handling data mismatch than others. If the test data subset is not robust then selecting a classifier that worked well on a training data subset with similar overall properties may be a mistake, because the training data set may not have reflected this significant data mismatch. This phenomenon is frequent in, for example, financial data. As another example, this phenomenon is also frequent in sonar data.

Referring still to the second embodiment of a program (200), when the estimate-feature-robustness process (220) completes control passes next to the characterize-good-feature-probability-density-function process (230). The characterize-good-feature-probability-density-function process (230) calculates metafeatures that describe the underlying class-conditional good feature distribution. These computed metafeatures characterize the underlying good feature distribution. The analysis of output good features identifies parameters (metafeatures) characterizing the distribution of those features over the data set. This calculation on the target good feature distribution calculates a set of “features of features” (metafeatures) providing an additional level of abstraction. (Took care of this comment earlier)

When the characterize-good-feature-probability-density-function process (230) is completed, control passes next to the transform-into-DM-algorithm-space process (240). The transform-into-DM-algorithm-space process (240) will transform the source vector (x), comprising the calculated metafeatures and also the indicated user preferences or other constraints regarding real-time operation of a deployed DM-algorithm, into DM-algorithm space (y). This transform identifies an optimal or near-optimal suite of DM-algorithms for the given case's source data and constraints. In one embodiment, use of a direct mapping process can exploit inherent relationships between and among features and classifiers to select the optimal or near-optimal mapping algorithm.

When the transform-into-DM-algorithm-space process (240) is complete, control passes next to the update-training-database process (250). A training database is updated after identification of a suite of optimal or near optimal DM-algorithms for a given case or instance. The training database as a knowledge repository becomes more comprehensive after each case or instance for which it is updated. More exercises with real DM data can therefore improve the performance of the DM-algorithm selection program. The program thus has the ability to learn and improve its performance with experience. When the update-training-database-process (250) finishes, the DM-algorithm selection program has completed.

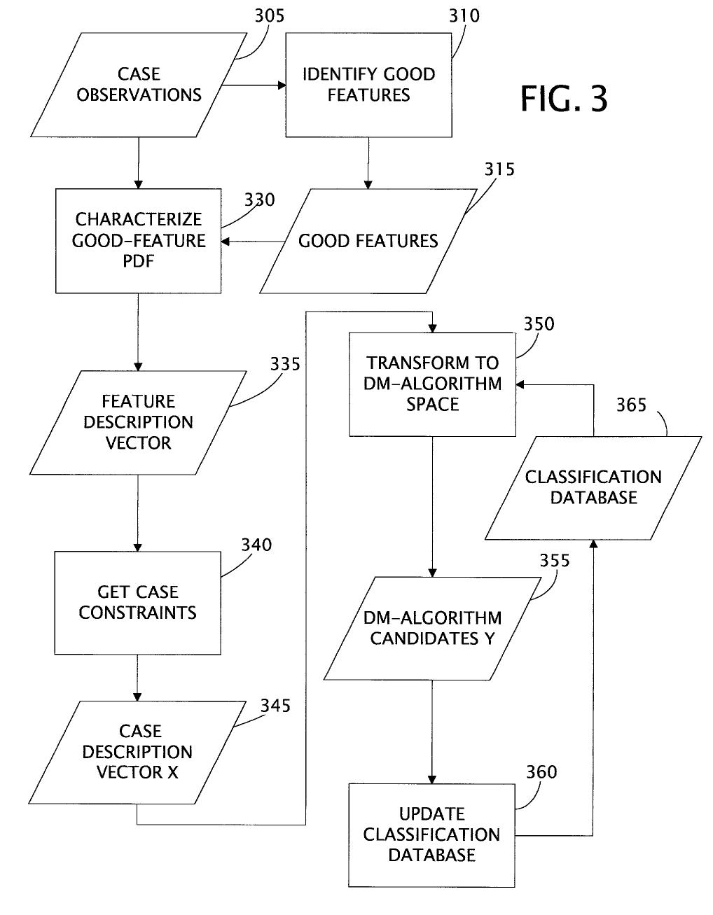

Referring now to FIG. 3, there is illustrated one embodiment of a transfer of control and flow of data in an embodiment for improved DM-algorithm selection. Case observation data (305) comprises the observed, measured, sensed, or recorded data to which the user desires to apply a DM-algorithm. An identify-good-features process (310) assesses features extractable from and classifiers applicable to the case observation data (305) to find a point of diminishing returns at which the addition of more features or classifiers will not improve performance. The identify-good-features-process (310) produces good feature data (315) identifying the features and/or classifiers having a reduced problem dimension. These identified good features (315) describing the underlying good feature distribution may be assembled into any suitable data structure.

The identify-good-features process (310) essentially performs feature extraction. Feature extraction is explained generally hereinbelow. A more detailed discussion of feature extraction of the type performed by the identify-good-features process (310) can be found in Chapter 3 of David H. Kil & Frances B. Shin, PATTERN RECOGNITION AND PREDICTION WITH APPLICATIONS TO SIGNAL CHARACTERIZATION (American Institute of Physics, 1996), which chapter is herewith incorporated herein by reference.

Feature extraction in general refers to a process by which data attributes are computed and collected. For example, in one embodiment data attributes may be collected in a compact vector form. Feature extraction may be considered as analogous to data compression that removes irrelevant information and preserves relevant information from the raw data.

Good features may possess one or more of several following desirable traits. For example, one desirable trait of good features is a relatively larger interclass mean distance and small interclass variance. Another desirable trait is that they be relatively less sensitive to extraneous variables. Another desirable trait is that good features be relatively computationally inexpensive to measure. Still another desirable trait is that they be relatively uncorrelated with other good features. As another desirable trait good features may also be mathematically definable, and, as yet another trait, explainable in physical terms. These desirable traits may be relative, in which case features can be ranked with respect to that particular relative trait. Other desirable traits may be absolute, such that good features either qualify as having that absolute trait or fail as not having that trait.

Because it may be difficult to find features that satisfy all of the above desirable properties, features extraction has in the past depended on (1) the expertise of field professionals, (2) preliminary data processing and visualization of various projection space representations, and (3) the user's understanding of signal physics. One embodiment of this invention automates this process, decreasing reliance on the expertise of the user.

Referring still to the embodiment in FIG. 3, a characterize-good-feature-probability-density-function process (330) calculates a metafeature description vector (335) describing the distributions of the good features data (315) over the case observation data (305). The metafeature description vector (335) comprises a list of “features of features” (metafeatures) describing the distribution of the good feature.

For example, the characterize-good-feature-probability-density-function process (330) may calculate as one metafeature the number of distinct modes of the probability density function. If, for example, the probability density function is relatively unimodal, then certain classes of DM-algorithms may be favorably indicated. On the other hand, if the probability density function is bimodal or relatively multimodal, then the same DM-algorithms may well be contraindicated.

As another example, the characterize good-feature probability density function process (330) may compute as another metafeature the relative degree of normality of the probability density function for each given mode. Thus characterizing the shapes of the most prominent nodes may assist in identifying the most appropriate DM-algorithm.

As still another example, the characterize good-feature probability density function process (330) may compute as still another metafeature the degree of nonlinearity of the probability density function. This computation may be performed, for example, by determining boundary functions derived from a binary tree classifier. This measures the degree of nonlinearity that further assists in finding the most appropriate DM-algorithm. The data characterization module may use any known characterization algorithm with characteristics suitable for the desired application. More metafeatures can be extracted to provide an additional level of details, such as polynomial description of class boundaries using image segmentation, feature-space overlap using information theoretic measures, etc.

The get-case-constraints process (340) in the embodiment shown in FIG. 3 appends this list of constraints to the metafeature description vector (335), resulting in a case description vector x (345). The get-case-constraints process (340) determines user preferences and run time limitations such as available memory, processor speed, and throughput that will restrict the range of acceptable DM-algorithms in DM-algorithm space. The get-case-constraints process (340) incorporates user preferences and constraints associated with real-time implementation of the selected DM-algorithm. The get-case-constraints process (340) may query the user for preferences and assess resources at runtime, or that information may be encoded along with the input data sets. Parameterization may occur in parallel with feature extraction, data mismatch detection, and feature characterization. Real-time deployment issues relevant to the get case constraints process (340) may include, for example, available memory, the size of the training database, and available throughput. The parameters identified by the get case constraints process (340) are appended to the data structure such as a vector containing metafeatures generated by the characterize good-feature probability density function process (330) for use by a transform to DM-algorithm space process (350) in identifying the most appropriate DM-algorithms.

Referring still to the embodiment in FIG. 3, a transform-to-DM-algorithm-space process (350) then maps the case description vector x (345) onto the DM-algorithm candidates y data (355) in order to find the best set of DM-algorithms. This direct mapping exploits the inherent relationship between features and classifiers to select optimal mapping algorithm. Direct mapping by the classification module eliminates the ad hoc step of selecting appropriate classification algorithm or of profiling classifiers as required by other approaches, and takes advantage of richness and mapping algorithms. Although one set of data structures has been illustrated in this embodiment depicted in FIG. 3, other data structures may be used without departing from the spirit of the invention.

The transform-to-DM-algorithm-space process (350) may utilize a classification database (365). This transform-to-DM-algorithm-space process (350) maps input metafeatures to a dependent variable, which records classification performance of each classifier under a range of operational parameters. The transform-to-DM-algorithm-space process (350) may incorporate an optimization algorithm that uses the classification database (365) to find the mapping function. The mapping function is used to find an appropriate set of candidate DM-algorithms.

The transform-to-DM-algorithm-space process (350) maps the distribution characterization of vector with appended parameters onto algorithms space. The transform-to-DM-algorithm-space process (350) includes discovery of the most promising DM-algorithm candidates for the problem-at hand. This mapping step may be based on a massive classification database. The mapping step in one embodiment may use, for example, a hybrid Bayesian network to map input metafeatures and user preferences onto output DM-algorithm space. In certain other embodiments a simple classifier may replace a complex hybrid Bayesian network. That is, if the underlying constraints and requirements as expressed by user preferences are complex, a hybrid Bayesian network may be needed. On the other hand, if the user is interested in performance alone (i.e., no constraint), then any classifier that provides a high degree of model match with the underlying good-feature distribution will suffice. Examples of simple classifiers include multivariate Gaussian classifier, discrimination-adaptive nearest neighbor, support vector machines, probabilistic neural networks, Gaussian mixture models, radial basis function, etc. Any known mapping technique with characteristics suitable for the desired application may be used.

In one embodiment, a hybrid Bayesian network may be used to include a diverse set of metafeatures in the decision making process. The diverse set of metafeatures may include, for example, user preferences, computational resource constraints, and metafeatures that characterize the good feature distribution, and data mismatch errors. Persons of ordinary skill in the art will appreciate that the diverse set of metafeatures may include other specific metafeatures. In one embodiment the diverse set of metafeatures includes other such metafeatures known to those of ordinary skill in the art but not specifically recited herein. This approach of using a hybrid Bayesian network to include a diverse set of metafeatures in the decision making process may be particularly advantageous if there is an inherent hierarchical, causal relationship between the features.

In one embodiment the mapping algorithm of the transform-to-DM-algorithm-space process (350) may output the top three DM-algorithms, which are then inserted automatically into the data mining operation. Final algorithm selection may be based on the judicious fusing of the three output DM-algorithms using techniques such as the Fisher discrimination ratio, bagging, boosting, stacking, forward error correction, and hierarchical sequential pruning.

An update-classification-database process (360) modifies the training database. The update classification database process (360) in the illustrated embodiment in FIG. 3 operates on the training database, which contains a collection of data mining experience. It includes both real data as starting points and actual performance results. The knowledge repository becomes more complete as more data mining exercises are performed on real data. Continuous updating ensures that the massive classification database continues to provide a good training database. The training database is constantly updated, and contains the entire collection of data mining experiences.

The classification database (365) of the continuous updating module may include, in one embodiment, a matrix. The columns of the matrix are each metafeature vectors extracted from various data mining exercises. The first N rows of the matrix each correspond to a metafeature or a constraint from the case description vector x. For an individual column, the first N rows are the case description vector x from that particular data mining exercise. The final row represents the best DM-algorithm. Each new case is appended to the end of the matrix by adding another column vector representing a learning experience.

The training database of the continuous updating module may also included in one embodiment a comprehensive rulebook summarizing which DM-algorithms are particularly appropriate or singularly inappropriate for given user preferences and resource constraints. This module transforms the available algorithms space onto a subset of that space including appropriate and excluding inappropriate algorithms. The performance of each of the algorithms and the metafeature vector characterizing the feature probability density function thus may be fed back into the training database so that the training can be updated on what works and what does not.

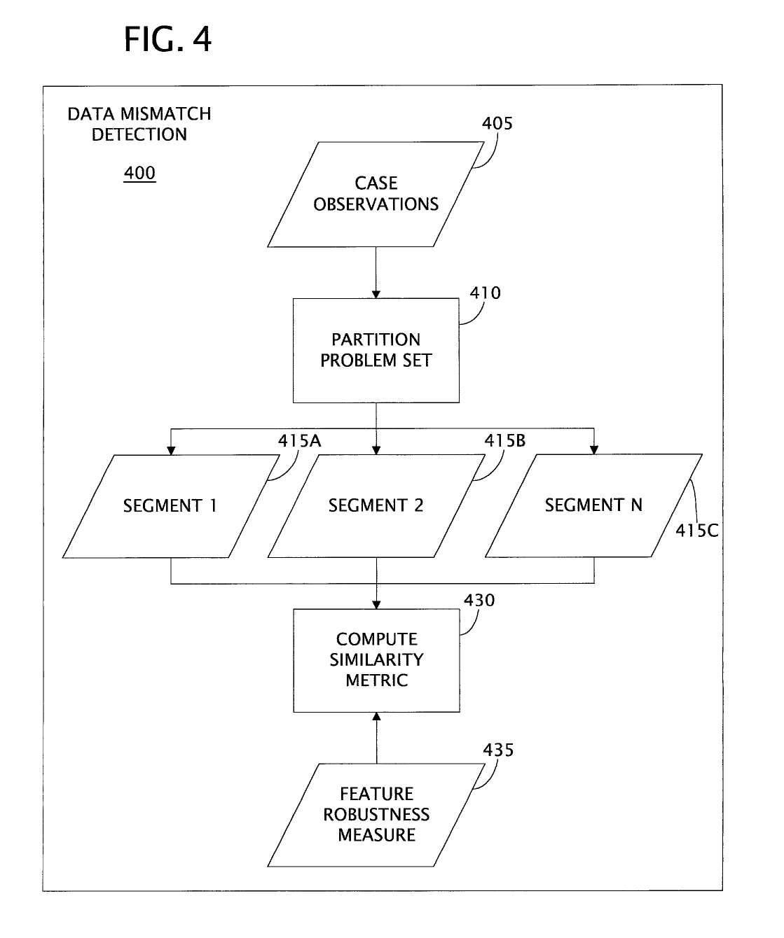

Referring now to the subprogram depicted in FIG. 4, there is shown a data flowchart depicting the flow of data and transfer of control in a subprogram for illustrating one embodiment of a data mismatch detection process (400). The data mismatch detection process (400) is one embodiment of an estimate feature robustness process (220) as depicted in FIG. 2. Case observations data (405) comprise the observed, measured, sensed, or recorded data to which the user desires to apply a DM-algorithm for analysis of a particular case. A partition problem set process (410) divides the observations from case observations data (405) into at least two and possibly more segments. If N segments are partitioned the segments may be numbered 1, 2, and so forth up to N. In the embodiment shown in FIG. 4 these multiple segments are represented by segment 1 data (415A), segment 2 data (415B), and segment N data (415C). The data mismatch detection process (220) partitions the entire data set into separate training and test subsets.

In one embodiment, the data-mismatch-detection process (220) partitions the case observation data (405) into temporal segments (for example, the first and second halves). In a second embodiment, the data-mismatch-detection module (220) performs cross-validation, which partitions the case observation data (405) into multiple sets of training and test subsets, one for tuning the classifier parameters (training) and the other for evaluating the performance of the tuned classifier (testing). There are many different ways to partition an available data set into independent training and test data subsets. These different partitioning techniques are considered equivalent and are intended to be encompassed in the scope of the data mismatch detection process (220).

Referring still to the embodiment of the data-mismatch-detection process (220) depicted in FIG. 4, after the case observation data (405) is partitioned into segments (415A, 415B, and 415C), control passes next to a compute-similarity-metric process (430). The compute-similarity-metric process (430) characterizes underlying good feature distributions, computes statistical measures of similarity (entropy or information theoretic measures), and quantifies the degree of data mismatch as a function of good features. In general, data mismatch detection estimates feature robustness.

A data-mismatch-detection process (220) is needed because some classifiers are better at handling data mismatch errors than others. In general, two factors—model mismatch and data mismatch—influence data mining performance. Model mismatch arises if the underlying learning algorithm is incapable of capturing the training-data characteristics, typically mainly because it does not have enough degrees of freedom. For example, a linear discriminator would not be able to fit nonlinear complex boundaries, whereas more sophisticated support vector machines would perform better. On the other hand, data mismatch occurs when there are statistically significant differences between training and test data. In this case, the opposite effects are often observed. That is, learning algorithms that fit the training data better by virtue of being able to tune their internal parameters may actually perform worse on the actual test data. If the new data set is not robust, selecting the classification algorithm that worked well on a previous data set with similar overall properties may be a mistake if that prior data set did not suffer from significant data mismatch. This problem typically arises, for example, in financial analysis or sonar data analysis when environmental conditions change.

Assembly of a classification database and identification of the features of features (metafeatures) to use may be facilitated by selection of an appropriate classifier taxonomy. Some specific examples are discussed generally below. This subject matter discussed extensively in Chapter 4 of David H. Kil & Frances B. Shin, PATTERN RECOGNITION AND PREDICTION WITH APPLICATIONS TO SIGNAL CHARACTERIZATION (American Institute of Physics, 1996), which chapter is herewith incorporated herein by reference.

As one example, if the metafeatures that describe the class conditional good feature probability density function are relatively unimodal with Gaussian characteristics, a simple multivariate Gaussian classifier may suffice. Classifiers relying on such a parametric structure typically make strong parametric assumptions on the underlying class-conditional probability distribution. Such classifiers are typically very simple to train, relying generally on straightforward statistical computations. However, performance of such parametric models may degrade significantly due to model mismatch if the strong parametric assumptions prove unfounded.

If, as another example, metafeatures that describe the class-conditional good-feature probability density function exhibit multimodal characteristics, then either a K-nearest neighbor or Gaussian mixture model may be more appropriate. Classifiers based on such nonparametric structure generally make no parametric assumptions. Such classifiers learn distribution from the data. They are typically more expensive to train in most instances than, for example, a multivariate Gaussian classifier. Even without parametric assumptions, such classifiers may nonetheless be vulnerable to data mismatch between the training and test data sets

As a third example, if metafeatures that describe the class-conditional good-feature probability density function show nonlinear boundaries, then some neural networks that more accurately model nonlinear functions may be a more appropriate choice. Such classifiers attempt to construct linear or nonlinear boundary conditions that distinguish between multiple classes. These classifiers are often expensive to train. The internal parameters are determined heuristically in most instances.

Those of ordinary skill in the art will appreciate that the algorithm universe is very large. Multivariate Gaussian classifier, K-nearest neighbor, neural networks, and hybrid Bayesian networks are each just examples representing small subsets of the algorithm universe. The disclosed embodiments provide solutions spanning essentially the entire algorithm solution space, not just small subsets thereof.

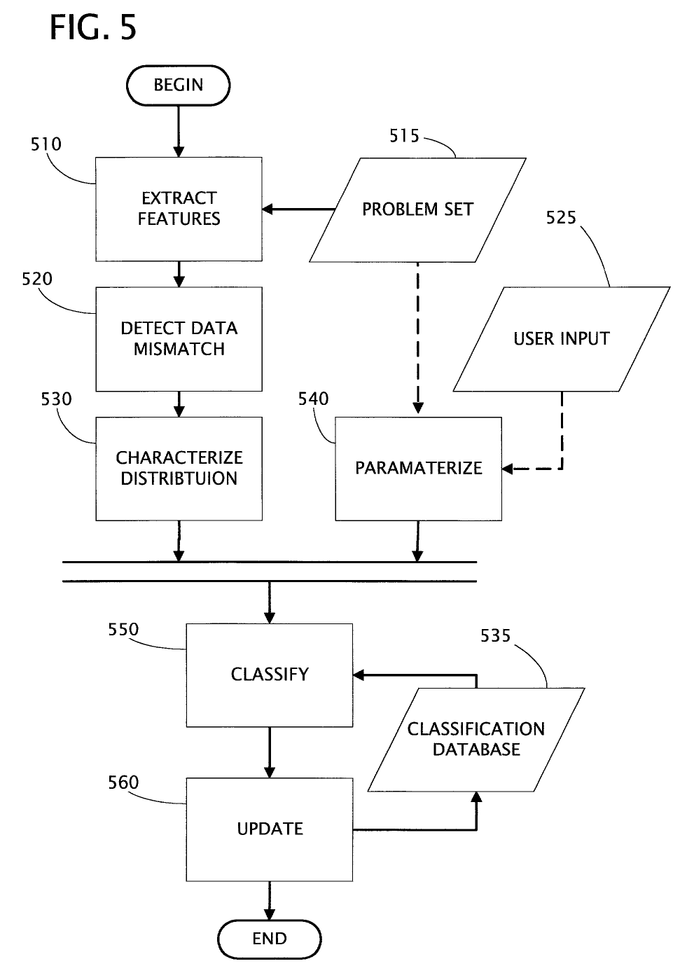

Referring now to FIG. 5, there is shown a system flowchart of one embodiment of program for improved algorithm selection in data mining. When this embodiment of the program begins control passes first to an extract feature code module (510). Feature extraction is based on underlying good feature distribution. The extract feature code module (510) calculates an optimal problem dimension, which reflects the number of distinct features encompassed. The extract feature code module (510) finds a point of diminishing returns, i.e., the point at which the inclusion of more features does not enhance the selection of the most appropriate data mining algorithm. The extract feature code module (510) thus finds the inflection point in classification performance. This procedure eliminates redundant and irrelevant features from further consideration.

In the embodiment pictured in FIG. 5, a detect data mismatch code module (520) estimates feature robustness with the similarity metric as a function of temporal segments and randomly partitioned segments. A characterize distribution code module (530) then calculates metafeatures to describe the underlying output/target/class-conditional good-feature distribution. A parameterize code module (540) incorporates user preferences and constraints associated with real-time implementation of the selected data mining algorithm. The parameterize code module (540) may query for user input data (525) regarding preferences, or that information may be encoded along with the problem set data (515). Parameterization may occur in parallel with execution of the extract feature code module (510), the detect data mismatch code module (520), and the characterize distribution code module (530). Real-time deployment issues include, for example, available memory, the size of any relevant classification database (535), and available throughput. The parameters identified by the parameterize code module (540) are appended to the vector of metafeatures generated by the characterize distribution code module (530) for use by a classify code module (550) in identifying the most appropriate data mining algorithms.

The classify code module (550) transforms the metafeatures from the characterize distribution code module (530) along with users preferences for the real-time operation from the parameterize code module (540) into the data mining algorithm space in order to find the best set of data mining algorithms. The classify code module (550) uses a classification database (535) to map from metafeature space to DM-algorithm space. Direct mapping in this embodiment exploits the inherent relationship between metafeatures and classifiers to select optimal mapping algorithm. Direct mapping by the classification module eliminates the ad hoc step of selecting appropriate classification algorithm or of profiling classifiers as required by other approaches, and takes advantage of richness and mapping algorithms.

A update code module (560) in the embodiment illustrated in FIG. 5 operates on the classification database (535), which contains the entire collection of data mining experience. Continual updating modifies the classification database (535). It includes both real data as starting points and actual performance results. The knowledge repository reflected in the classification database (535) thus becomes more complete as more data mining exercises are performed on real data.

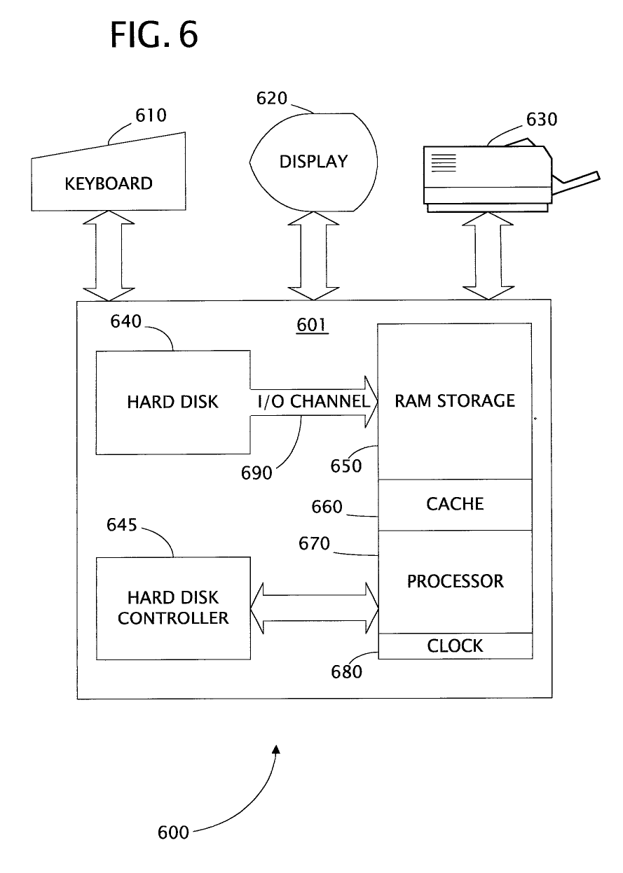

Referring now to FIG. 6, there is disclosed a block diagram that generally depicts an example of a configuration of hardware (600) suitable for automatic mapping of raw data to a processing algorithm. A general-purpose digital computer (601) includes a hard disk (640), a hard disk controller (645), ram storage (650), an optional cache (660), a processor (670), a clock (680), and various I/O channels (690). In one embodiment, the hard disk (640) will store data mining application software, raw data for data mining, and an algorithm knowledge database. Many different types of storage devices may be used and are considered equivalent to the hard disk (640), including but not limited to a floppy disk, a CD-ROM, a DVD-ROM, an online web site, tape storage, and compact flash storage. In other embodiments not shown, some or all of these units may be stored, accessed, or used off-site, as, for example, by an internet connection. The I/O channels (690) are communications channels whereby information is transmitted between RAM storage and the storage devices such as the hard disk (640). The general-purpose digital computer (601) may also include peripheral devices such as, for example, a keyboard (610), a display (620), or a printer (630) for providing run-time interaction and/or receiving results. Prototype software has been tested on Windows 2000 and Unix workstations. It is currently written in Matlab and C/C++. A copy of the program files in Matlab and C/C++ is included on the accompanying appendix incorporated by reference hereinabove. Two embodiments are currently envisioned: client server and browser-enabled. Both versions will communicate with the back-end relational database servers through ODBC (Object Database Connectivity) using a pool of persistent database connections.

The data mining software application described herein will operate in a general purpose computer. A computer is generally a functional unit that can perform substantial computations, including numerous arithmetic operations and logic operations without human intervention. A computer may consist of a stand-alone unit or several interconnected units. In information processing, the term computer usually refers to a digital computer, which is a computer that is controlled by internally stored programs and that is capable of using common storage for all or part of a program and also for all or part of the data necessary for the execution of the programs; performing user-designated manipulation of digitally represented discrete data, including arithmetic operations and logic operations; and executing programs that modify themselves during their execution. A functional unit is considered an entity of hardware or software, or both, capable of accomplishing a specified purpose. Hardware includes all or part of the physical components of an information processing system, such as computers and peripheral devices.

A computer will typically include a processor, including at least an instruction control unit and an arithmetic and logic unit. The processor is generally a functional unit that interprets and executes instructions. An instruction control unit in a processor is generally the part that retrieves instructions in proper sequence, interprets each instruction, and applies the proper signals to the arithmetic and logic unit and other parts in accordance with this interpretation. The arithmetic and logic unit in a processor is generally the part that performs arithmetic operations and logic operations.

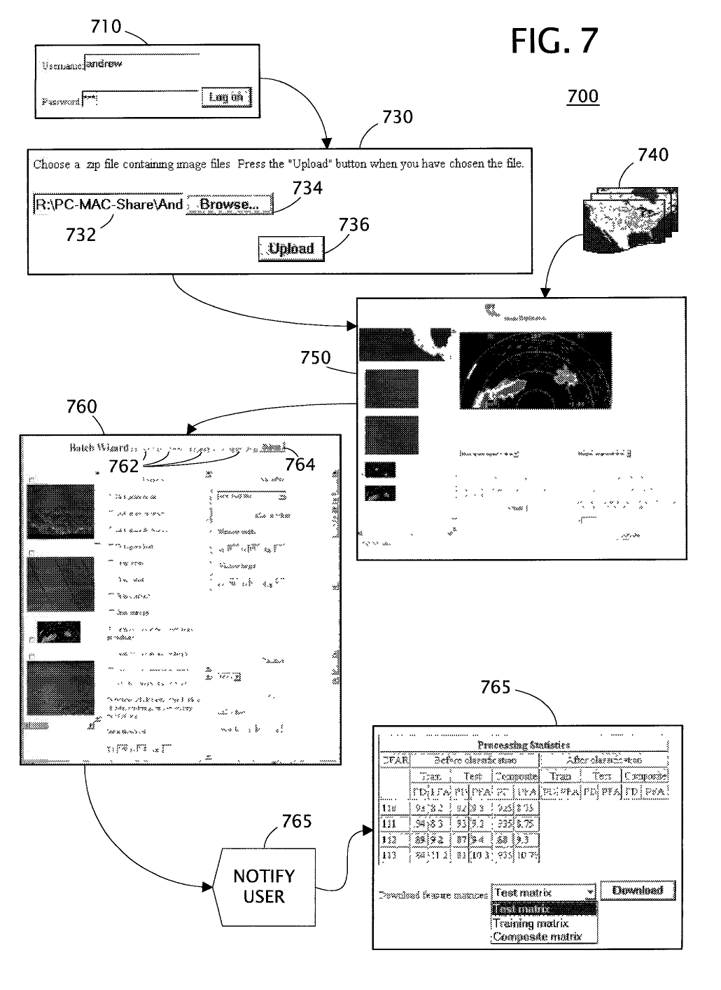

Referring now to FIG. 7, there is generally depicted browser based data mining application (700) as one alternative embodiment of the data mining application of the current invention. This browser based application is capable of running on a distributed computer network. A distributed computer network includes a plurality of computers connected and communicating via a protocall such as, for example, internet protocal, TCP/PI, NetBUI, or the like. In this embodiment pictured in FIG. 7, data mining is performed remotely using data and parameters that may be submitted over a network such as the internet using a network interface application such as a web browser. The user of such a browser based product may communicate information to the browser based product by means of dialogs screens displayed on the browser. The description below explains in more detail the functioning of the particular embodiment depicted in FIG. 7, but other embodiments are possible and are intended to be included within the scope of the invention. An advantage of an embodiment that is browser based is that more computational power may be available for the actual data mining than may have been available locally to an individual user. The browser-based embodiment in FIG. 7 is illustrated generally as a series of windows and dialogs. A window (or display window) is, in general, a part of a display image with defined boundaries, in which data is displayed. A display image is, in general, a collection of display elements that are represented together at any one time on a display surface. A display element is, in general, a basic graphic element that can be used to construct a display image. Examples of such a display element include a dot or a line segment.

In the example browser based data mining application (700), the user is first presented with a log-in dialog (710) in which the user enters a user identification and password. The log-in dialog (710) can provide security in the browser based data mining application (700), and can permit information to be stored on the remote server about data mining activity by a particular user. Storing such information on a remote server can permit the browser based data mining application (700) to adapt to the particular preferences of an individual user.

Referring still to the embodiment illustrated in FIG. 7, after the user has entered the user identification and proper password in the log-in dialog (710), the browser based data mining application (700) passes control (720) to an upload data files dialog (730). The data file (740) identified in the upload data files dialog (730) may be, for example, image data files or digital signal data files. In the embodiment depicted in FIG. 7, the upload data file dialog (730) includes a file identifier text box (732), a browse button (734), and an upload button (736). The user may type into the file identifier text box (732) a unique identifier of the storage location of the file. Examples of such unique identifiers include, but are not limited to, the file name, the fully qualified file and path name, a uniform resource locator name, a network path name, and the like. Alternatively, in the embodiment depicted in FIG. 7, the user may identify select the unique identifier by a graphical user interface activated by clicking the browse button (734), which can then fill in the file identifier text box (732) after the file has been selected. After the user has identified a file, whether by typing information into the file identifier text box (732) or by means of a graphical user interface activated with the browse button (734), the user may submit the information through the browser based data mining application (700) by clicking the upload button (736). Clicking the upload button (736) will cause the data file (740) to be transmitted to the data mining application.

After the user clicks the upload button (736) to upload the data file (740), control next passes to a data exploration dialog (750). In the data exploration dialog (750) depicted in the particular embodiment of FIG. 7, the user may preprocess and segment data. For data files (740) that contain image data, the data exploration dialog may include options to permit the user to segment images and explore image characteristics. For example, the user may be given the option to select from automatically generated thumbnails of uploaded images. The image list in one embodiment may include images from all sessions. The data exploration dialog (750) may also include a data file history that provides a history of algorithms performed on a particular data file (740), including parameters. Such a data file history may facilitate evaluating the performance of composite algorithms. The data exploration dialog (750) may also display or otherwise communicate processed data, such as processed images or processed digital signals. Processed data may then be warehoused in the database, facilitating post-processing viewing and analysis. The data exploration dialog (750) may further include the ability to select between several and various algorithms such as, for example, preprocessing, filtering, and segmentation algorithms. Additionally, the data exploration dialog (750) may provide the capacity to change algorithm parameters and information about each parameter, as well as a suggested default value.

Referring still to the embodiment illustrated in FIG. 7, after the data exploration dialog (750) has completed, control may pass to a batch submission dialog (760). In the batch submission dialog, the user may specify a processing string including preprocessing, filtering, global algorithms, detection, metafeature extraction, and evaluation. In one version of the product, parameter ranges may be used to allow multiple executions to obtain locally optimal algorithm parameters. The batch submission dialog (760) may also include one or more data exploration dialog links (762), selection of which can be operable to transfer control to other dialogs. As further shown in this particular embodiment, the batch submission dialog (760) may also include a submit button (764). When the user clicks on the submit button (764), the data mining problem can be submitted across the network. The data mining problem will be loaded into a queue of data mining problems at the central computer, where it can be taken in order according to any convenient scheme for assigning priority to batch jobs such as, for example, a “first-in, first-out” rule.

Referring still to the embodiment pictured in FIG. 7, after the batch submission dialog (760) is complete, the job may wait in queue until a central server processes the job. After the central server has processed the job, it can next end a notification (765) to the user that the job has been processed. In particular embodiments the notification may be in the form of an email, an instant message, or any other suitable form of notification. After the user has receives the notification (765), the user can access a report (770) describing the results of the batch job The report may, in one embodiment, give the probability of detection and probability of a false alarm for the Cartesian product of algorithm parameters.

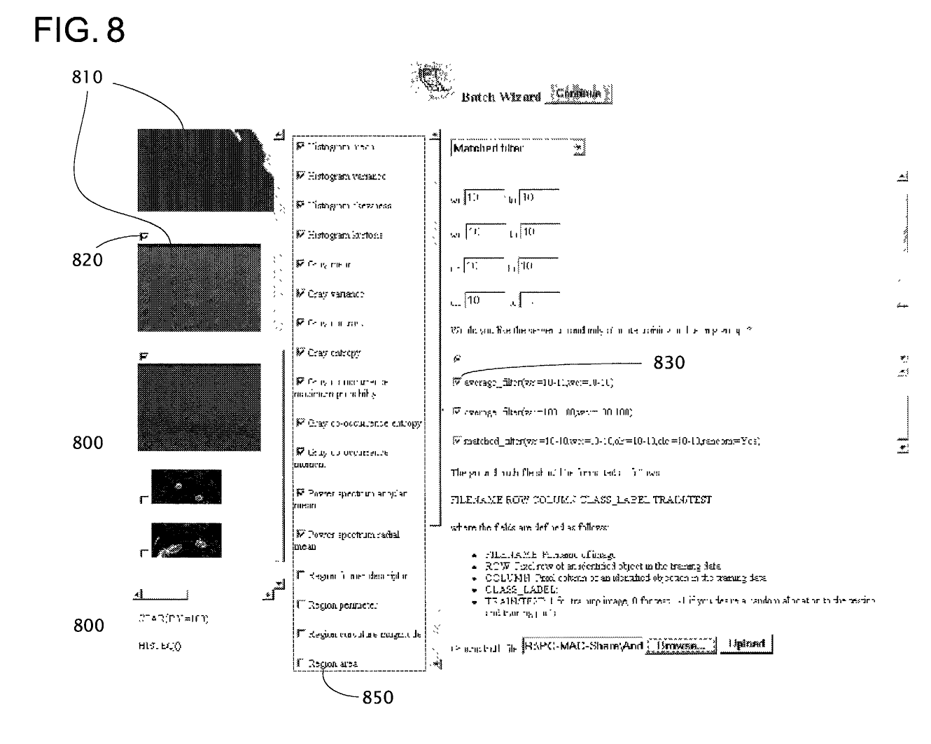

Referring now to the embodiment depicted in FIG. 8, there is shown an example of an embodiment including an alternate batch submission dialog (800) similar to the batch submission dialog (760) depicted in FIG. 7. The alternate batch submission dialog (800) dialog may present data from the data file (740) and give the user the option of whether to include that data in the batch file. in the example shown the alternate batch submission dialog (800) shows information for a data file (740) containing image data, but other examples of the batch submission dialog (800) may be adapted to solicit information concerning any other type of data file (740) such as a digital signal data file. The alternate batch submission dialog (800) in the particular embodiment shown may display the images (810) and present a check box (820). By filling in or clearing the check box (820) users can alternatively select the associated image for inclusion or exclusion in the data mining batch being submitted. The alternate batch submission dialog (800) may also permit the user to choose from various algorithms such as preprocessing, segmentation, detection, and global algorithms, as well as matched and finite impulse response filters. The alternate batch submission dialog (800) may also provide information about each parameter, as well as a suggested default value. It may, further, display a list of selected algorithms in order, with parameters. A check box (830) may be provided which can be cleared to eliminate an algorithm from the list. The alternate batch submission dialog (800) may also include a feature matrix (850) from which the user can select, from a list of intensity-domain, frequency-domain, and region-domain features, those items to be extract from processed images.

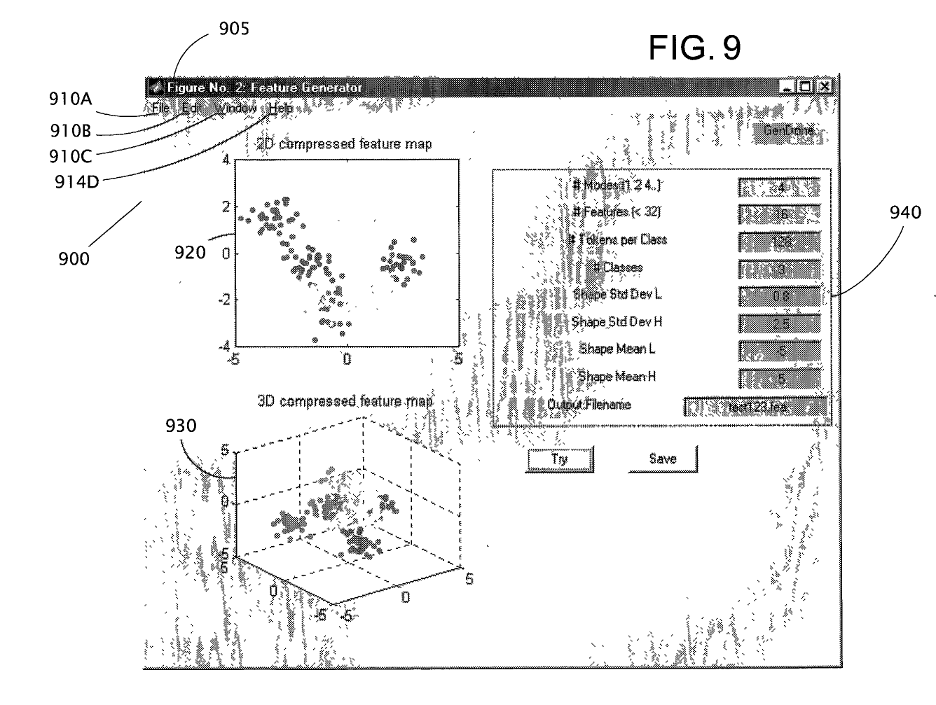

FIG. 9 shows one aspect of an embodiment. The aspect shown regards feature optimization. In this particular aspect of this embodiment, a feature generator window (900) includes a title bar (905) bearing the title as “Figure No. 2: Feature Generator.” The feature generator window (900) in this embodiment also includes conventional menu items such as a file menu item (910A), an edit menu item (910B), a window menu item (910C), and a help menu item (910D). In this embodiment the feature generator window (900) also includes a 2D compressed feature map image (920). In the example shown the 2D compressed feature map image (920) shows clustering of features indicated by four different shades, where each shade represents a different output category This embodiment also includes a 3d compressed feature map (930), showing the clustering of clustering of features indicated by four different shades. This embodiment also includes a text display area (940), in which particular parameters and other information are displayed in labeled text boxes. The feature generator window (900) is used in feature optimization, to identify a reduced dimension subspace that provides maximum class separation. In one embodiment this identification can involve feature ranking by combinatorial optimization and/or dimension reduction by feature transformation.

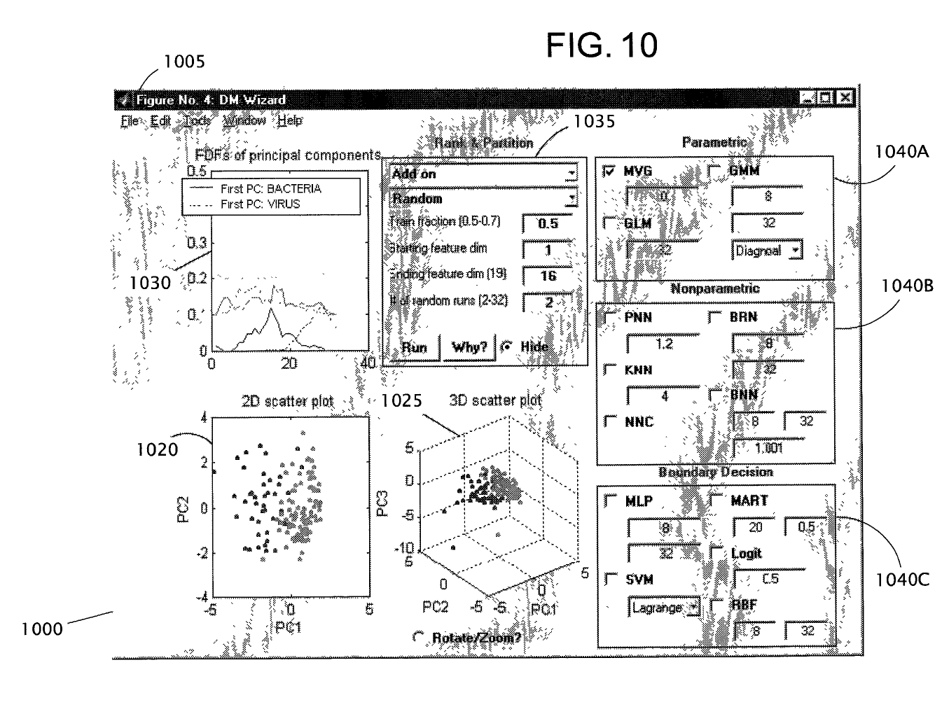

In another embodiment of the invention, FIG. 10 depicts a window providing an interface for improved DM-algorithm selection in a data mining program. A data mining wizard window (1000) in this embodiment has a title bar (1005) bearing the title “DM Wizard.” In this embodiment the data mining wizard window (1000) includes a 2D compressed feature map display (1020) and a 3d compressed feature map display (1025), showing the clustering of clustering of features indicated by four different shades. This embodiment also includes a probability density function principal component display (1030) which displays the probability density function of principal components. The data mining wizard window (1000) in this embodiment also includes a rank and partition box (1035) that can be used to partition the problem set and/or estimate feature robustness. The data mining wizard window (1000) in this embodiment also includes a parametric selection box (1040A), a non-parametric selection box (1040B), and a boundary decision box (1040C), each of which indicates the selection of an algorithm of that category.

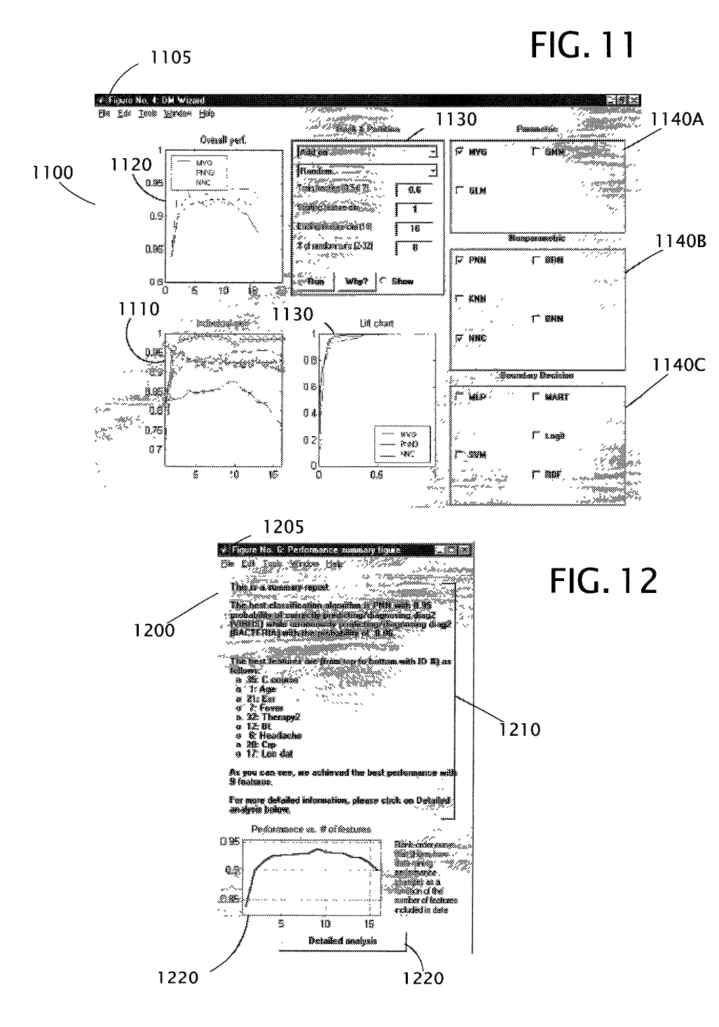

FIG. 11 depicts a second aspect of the same specific embodiment as shown in FIG. 10. Referring now to the aspect of an embodiment depicted FIG. 11, a data mining wizard window (1100) has a title bar (1105) bearing the title “DM Wizard.” The data mining wizard window (1100) also includes and individual performance display (1110), an overall performance display (1120), and a lift chart (1130). The individual performance display shows how well one can classify or predict each output category as a function of feature dimension. The overall performance display shows the average of individual performances, while a lift charts allows the user to assess the trade off between false positives and false negatives for each pair of possible output categories. The data mining wizard window (1100) in this embodiment also includes a parametric selection box (1140A), a non-parametric selection box (1140B), and a boundary decision box (1140C), each of which indicates the selection of an algorithm of that category.

FIG. 12 depicts another window from one aspect of an embodiment. A performance summary window (1200) has a title bar (1205) bearing the title “Performance summary figure.” In this embodiment a text box (1210) contains a narrative summary in natural language identifying the DM-algorithm selected and quantifying its performance. A detailed analysis button (1220) is provided, which the user can click for additional information. A performance chart display (1230) graphs the performance as a function of the number of features. This particular example also illustrates the importance of reducing problem dimension, because in this illustrated example performance actually deteriorates if more than nine features are used.

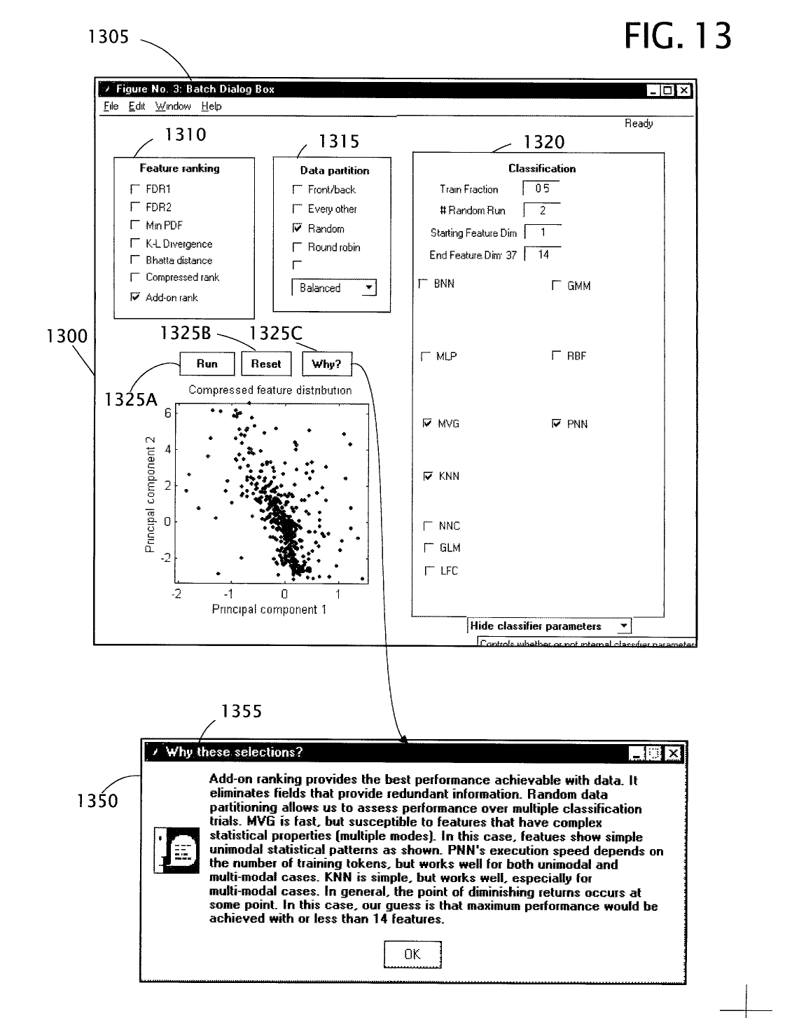

FIG. 13 depicts a window from one embodiment for Automated DM Algorithm Selection. A batch dialog box window (1300) has a title bar (1305) bearing the title “Batch Dialog Box.” A feature ranking display box (1310) in this embodiment reports the rankings of features evaluated. A data partition display box (1315) in this embodiment reports on the partitioning of data, whether temporally, randomly, or otherwise. A classification display box (1320) lists DM-algorithms and indicates which are selected. A run button (1325A) is provided in this embodiment, which the user can click to perform data mining with the options selected. The user is free to select additional algorithms depending on their familiarity with data and the level of algorithmic expertise. A reset button (1325B) is provided in this embodiment, which the user can click to restart. A why button (1325C) is provided in this embodiment, which the user can click to generate (as shown by the arrow) a why-these-selections window (1350). The why-these-selections window (1350) has a title bar (1355) bearing the title “Performance summary figure.” The why-these-selections window (1350) in this embodiment comprises a text box (1360) which can display a natural language narrative explaining the particular selections of DM parameters in the batch dialog box window (1300). This embodiment recommends a set of algorithms. The user has an option in this embodiment of accepting the recommended algorithm set or specifying a user-defined set. The option of specifying a user-defined set is preferably reserved for experts. Moreover, this entire selection can be made invisible to the user so that the user can proceed directly to the results.

An embodiment of invention may also assist users to focus on a small subset of available DM-algorithms. In embodiments in which this benefit is provided, the user can more easily grasp the DM-algorithm subspace and can more easily explore algorithm optimization parameters. An advantage of one embodiment is that the algorithm space need not be arbitrarily limited in the overall data mining application. The entire algorithms space may be made available for preprocessing by an embodiment of this invention. Another embodiment may further provided for user definition of the DM-algorithms to be tested. Thus making available a large selection of tools in the form of various DM-algorithm may improve overall data mining performance and may serve to improve the range of data mining problems for which acceptable performance may be obtained.

Although embodiments have been shown and described, it is to be understood that various modifications and substitutions, as well as rearrangements of parts and components, can be made by those skilled in the art, without departing from the normal spirit and scope of this invention. Having thus described the invention in detail by way of reference to preferred embodiments thereof, it will be apparent that other modifications and variations are possible without departing from the scope of the invention defined in the appended claims. Therefore, the spirit and scope of the appended claims should not be limited to the description of the preferred versions contained herein. The appended claims are contemplated to cover the present invention any and all modifications, variations, or equivalents that fall within the true spirit and scope of the basic underlying principles disclosed and claimed herein.

1. A data mining algorithm selection method for selecting a data mining algorithm for data mining analysis of a problem set, the data mining algorithm selection method comprising:
providing data to be analyzed by data mining;
providing a training database comprising a list of data mining algorithm instances, each data mining algorithm instance comprising a data mining algorithm description and a set of training metafeatures characterizing probability density functions of features;
extracting features that classify the data, the frequency of the occurrence of features with respect to datum in the data defining a case probability density function;
calculating metafeatures describing the case probability density function; and
selecting a data mining algorithm by using the training database to map the calculated metafeatures describing the case probability density function to the selected data mining algorithm.

2. The data mining algorithm selection method according to claim 1 further comprising updating the training database to include the selected data mining algorithm and the calculated metafeatures as a new data mining algorithm instance.

3. The data mining algorithm selection method according to claim 1, in which the extracting features further comprises:
identifying a point of diminishing returns with respect to the number of features extracted; and
estimating features robustness.

4. The data mining algorithm selection method according to claim 3, in which estimating feature robustness further comprises partitioning problem set data into subsets.

5. The data mining algorithm selection method according to claim 4, in which partitioning problem set data further comprises at least one act selected from the group consisting of partitioning the data set temporally, partitioning the data set sequentially, and partitioning the data set randomly.

6. The data mining algorithm selection method according to claim 4, in which estimating feature robustness further comprises calculating entropy of each subset as a statistical measure of similarity.

7. The data mining algorithm selection method according to claim 1 further comprising:
identifying a parameter; and
using the identified parameter in the act of selecting a data mining algorithm.

8. The data mining algorithm selection method according to claim 7 in which the parameter comprises at least one member selected from the group consisting of user preferences, real-time deployment issues, available memory, training data size, and available throughput.

9. The data mining algorithm selection method according to claim 1 in which selecting a data mining algorithm further comprises using a simple classifier.

10. The data mining algorithm selection method according to claim 1 in which selecting a data mining algorithm further comprises the act of using a Bayesian network.

11. The data mining algorithm selection method according to claim 1, in which act of calculating metafeatures describing the probability density function calculates metafeatures selected from a set consisting of the number of distinct modes of the probability density function, the degree of normality of the probability density function, a boundary-function description, and the degree of non-linearity of the probability density function.

12. The data mining algorithm selection method according to claim 1 further comprising:
selecting a plurality of data mining algorithms by using the training database to map the metafeatures describing the probability density function to the selected plurality of data mining algorithms; and
fusing the selected plurality of data mining algorithms into a composite data mining algorithm.

13. A data mining product embedded in a computer readable medium, comprising:
at least one computer readable medium having a training database embedded therein and having a computer readable program code embedded therein to select a data mining algorithm,
the training database comprising a list of data mining algorithm instances, each data mining algorithm instance comprising a data mining algorithm description and a set of metafeatures characterizing probability density functions of features;
the computer readable program code comprising:
computer readable program code to extract features that classify data, the frequency of the occurrence of features with respect to datum in the data defining a probability density function;
computer readable program code to calculate metafeatures describing the probability density function;
computer readable program code to select a data mining algorithm by using the training database to map the calculated metafeatures describing the probability density function to the selected data mining algorithm.

14. The data mining product embedded in a computer readable medium according to claim 13, the computer readable program code further comprising computer readable program code to update the training database to include the selected data mining algorithm and the calculated metafeatures as a new data mining algorithm instance.

15. The data mining product embedded in a computer readable medium according to claim 13, wherein the computer readable program code to extract features further comprises:
computer readable program code to identify a point of diminishing returns in the number of features; and
computer readable program code to estimate feature robustness.

16. The data mining product embedded in a computer readable medium according to claim 15, wherein the computer readable program code to estimate feature robustness further comprises computer readable program code to partition the data into subsets.

17. The data mining product embedded in a computer readable medium according to claim 16, wherein the computer readable program code to partition data further comprises computer readable program code selected from the set consisting of computer readable program code to partition the data set temporally, computer readable program code to partition the data set sequentially, and computer readable program code to partition the data set randomly.

18. The data mining product embedded in a computer readable medium according to claim 16, wherein the computer readable program code to estimate feature robustness further comprises computer readable program code to calculate the entropy of each subset as a statistical measure of similarity.

19. The data mining product embedded in a computer readable medium according to claim 13, the computer readable program code further comprising:
computer readable program code to identify parameters; and
computer readable program code to use the identified parameters in the computer readable program code for selecting a data mining algorithm.

20. The data mining product embedded in a computer readable medium according to claim 19, wherein the parameters selected from a set consisting of user preferences, real-time deployment issues, available memory, the training data size, and available throughput.

21. The data mining product embedded in a computer readable medium according to claim 13 wherein the computer readable program code to select a data mining algorithm further comprises computer readable program code to execute a simple classifier system.

22. The data mining product embedded in a computer readable medium according to claim 13 wherein the computer readable program code to select a data mining algorithm further comprises computer readable program code to execute a Bayesian network.

23. The data mining product embedded in a computer readable medium according to claim 13, wherein the computer readable program code to calculate metafeatures describing the probability density function calculates metafeatures selected from a group consisting of the number of distinct modes of the probability density function, the degree of normality of the probability density function, and the degree of non-linearity of the probability density function.

24. The data mining product embedded in a computer readable medium according to claim 13, further comprising:
computer readable program code to select a plurality of data mining algorithms by using the training database to map the metafeatures describing the probability density function to the selected plurality of data mining algorithms; and
computer readable program code to fuse the selected plurality of data mining algorithms into a composite data mining algorithm.

25. A data mining system with improved data mining algorithm selection for data mining analysis of data, the data mining system comprising:
a general purpose computer comprising a memory and a central processing unit;
a training database in the memory, the comprising a list of data mining algorithm instances, each data mining algorithm instance comprising a data mining algorithm description and a set of metafeatures characterizing probability density functions of features;
computer readable program code to extract features that classify data, the frequency of the occurrence of features with respect to datum in the data defining a case probability density function;
computer readable program code to calculate metafeatures describing the case probability density function; and
computer readable program code to select a data mining algorithm by using the training database to map the calculated metafeatures describing the case probability density function to the selected data mining algorithm.

26. The data mining system according to claim 25 further comprising computer readable program code to update the training database to include the selected data mining algorithm and the calculated metafeatures as a new data mining algorithm instance.

27. The data mining system according to claim 25 further comprising:
computer readable program code to identify a point of diminishing returns in the number of features; and
computer readable program code to estimate feature robustness.

28. The data mining system according to claim 27, wherein the computer readable program code to estimate feature robustness further comprises computer readable program code to partition the data into subsets.

29. The data mining system according to claim 28, wherein the computer readable program code to partition data further comprises computer readable program code selected from the set consisting of computer readable program code to partition the data set temporally, computer readable program code to partition the data set sequentially, and computer readable program code to partition the data set randomly.

30. The data mining system according to claim 28, wherein the computer readable program code to estimate feature robustness further comprises computer readable program code to calculate the entropy of each subset as a statistical measure of similarity.

31. The data mining system according to claim 25, wherein the computer readable program code in the computer program product further comprises:
computer readable program code to identify parameters; and
computer readable program code to use the identified parameters in the computer readable program code for selecting a data mining algorithm.

32. The data mining system according to claim 31, with the parameters selected from a set consisting of user preferences, real-time deployment issues, available memory, the training data size, and available throughput.

33. The data mining system according to claim 25 wherein the computer readable program code to select a data mining algorithm further comprises computer readable program code to execute a simple classifier system.

34. The data mining system according to claim 25 wherein the computer readable program code to select a data mining algorithm further comprises computer readable program code to execute a Bayesian network.

35. The data mining system according to claim 25, wherein the computer readable program code to calculate metafeatures describing the probability density function calculates metafeatures selected from a group consisting of the number of distinct modes of the probability density function, the degree of normality of the probability density function, and the degree of non-linearity of the probability density function.

36. The data mining system according to claim 25, further comprising:
computer readable program code to select a plurality of data mining algorithms by using the training database to map the metafeatures describing the probability density function to the selected plurality of data mining algorithms; and
computer readable program code to fuse the selected plurality of data mining algorithms into a composite data mining algorithm.

37. A data mining system with improved data mining algorithm selection for data mining analysis of data, the data mining system comprising:
a distributed network of computers;
a training database on the network, the training database comprising a list of data mining algorithm instances, each data mining algorithm instance comprising a data mining algorithm description and a set of metafeatures characterizing probability density functions of features;
computer readable program code to extract features that classify data, the frequency of the occurrence of features with respect to datum in the data defining a case probability density function; and
computer readable program code to calculate metafeatures describing the case probability density function;
computer readable program code to select a data mining algorithm by using the training database to map the calculated metafeatures describing the case probability density function to the selected data mining algorithm.

38. The data mining system according to claim 37 further comprising computer readable program code to update the training database to include the selected data mining algorithm and the calculated metafeatures as a new data mining algorithm instance.

39. The data mining system according to claim 37 further comprising:
computer readable program code to identify a point of diminishing returns in the number of features; and
computer readable program code to estimate feature robustness.

40. The data mining system according to claim 39, wherein the computer readable program code to estimate feature robustness further comprises computer readable program code to partition the data into subsets.

41. The data mining system according to claim 40, wherein the computer readable program code to partition data further comprises computer readable program code selected from the set consisting of computer readable program code to partition the data set temporally, computer readable program code to partition the data set sequentially, and computer readable program code to partition the data set randomly.

42. The data mining system according to claim 40, wherein the computer readable program code to estimate feature robustness further comprises computer readable program code to calculate the entropy of each subset as a statistical measure of similarity.

43. The data mining system according to claim 37, wherein computer readable program code further comprises:
computer readable program code to identify parameters; and
computer readable program code to use the identified parameters in the computer readable program code for selecting a data mining algorithm.

44. The data mining system according to claim 43, wherein the identified parameters are selected from a set consisting of user preferences, real-time deployment issues, available memory, training data size, and available throughput.

45. The data mining system according to claim 37 wherein the computer readable program code to select a data mining algorithm further comprises computer readable program code to execute a simple classifier system.

46. The data mining system according to claim 37 wherein the computer readable program code to select a data mining algorithm further comprises computer readable program code to execute a Bayesian network.

47. The data mining system according to claim 37, wherein the computer readable program code to calculate metafeatures describing the probability density function calculates metafeatures selected from a set consisting of the number of distinct modes of the probability density function, the degree of normality of the probability density function, and the degree of non-linearity of the probability density function.

48. The data mining system according to claim 37, comprising:
computer readable program code to select a plurality of data mining algorithms by using the training database to map the metafeatures describing the probability density function to the selected plurality of data mining algorithms; and
computer readable program code to fuse the selected plurality of data mining algorithms into a composite data mining algorithm.

49. A data mining application with improved data mining algorithm selection for data mining analysis of a problem set, the data mining application comprising:
a training database means for storing a list of data mining algorithm instances, each data mining algorithm instance comprising a data mining algorithm description and a set of metafeatures characterizing probability density function of features over a problem data set;
a means for extracting features that classify problem set data, wherein the frequency of the occurrence of features with respect to datum in the problem data set defines a probability density function;
a means for computing metafeatures describing the probability density function; and
a means for directly mapping the metafeatures describing the probability density function to a selected data mining algorithm using the training database means.

50. The data mining application according to claim 1 further comprising a means for updating the training database means to include the selected data mining algorithm and the metafeatures as a new data mining algorithm instance.

51. The data mining application according to claim 1 in which the means for extracting features further comprises:
a means for identifying a point of diminishing returns in the number of features; and
a means for estimating the robustness of features;

52. The data mining application according to claim 51, wherein the means for estimating feature robustness further comprises a means for partitioning problem set data into subsets.

53. The data mining application according to claim 52 wherein the means for partitioning problem set data uses a process selected from the set consisting of partitioning the data set temporally, partitioning the data set sequentially, and partitioning the data set randomly.

54. The data mining application according to claim 52, wherein the means for estimating feature robustness uses entropy of each subset as a statistical measure of similarity.

55. The data mining application according to claim 1 further comprised: a means for identifying parameters; wherein the means for directly mapping the metafeatures describing the probability density function to a selected data mining algorithm using the training database also uses the identified parameters.

56. The data mining application according to claim 54 wherein the parameters are selected from a set consisting of user preferences, real-time deployment issues, available memory, the size of training data, and available throughput.

57. The data mining application according to claim 1, wherein the means for directly mapping the metafeatures describing the probability density function to a selected data mining algorithm using the training database further comprises a simple classifier.

58. The data mining application according to claim 1, wherein the means for directly mapping the metafeatures describing the probability density function to a selected data mining algorithm using the training database further comprises a Bayesian network.

59. The data mining application according to claim 1, wherein the means for computing metafeatures computes metafeatures selected from a set consisting of the number of distinct modes of the probability density function, the degree of normality of the probability density function, and the degree of non-linearity of the probability density function.

60. The data mining application according to claim 1 further comprising
means for directly mapping the metafeatures describing the probability density function to a plurality of selected data mining algorithms using the training database; and
means for fusing the plurality of selected data mining algorithms into a composite data mining algorithm.
